(19) United States
(12) Patent Application Publication
(10) Pub. No.: US 2026/0168856 A1
(43) Pub. Date: Jun. 18, 2026

(54) METHOD AND SYSTEM FOR INFERRING ELECTRON TEMPERATURE FROM HOLLOW CATHODE PLUME COLOR

(71) Applicant: SHANGHAI INSTITUTE OF SPACE PROPULSION, Shanghai (CN)

(72) Inventors: Bo YU, Shanghai (CN); Jie CHEN, Shanghai (CN); Yizhou JIN, Shanghai (CN); Jia LIU, Shanghai (CN); Leichao TIAN, Shanghai (CN); Yan ZHANG, Shanghai (CN)

(21) Appl. No.: 19/416,365

(22) Filed: Dec. 11, 2025

(30) Foreign Application Priority Data
Dec. 13, 2024 (CN) 202411850924.0

(51) Int. Cl. G01J 5/00; G01J 5/0801; G01J 5/60

(52) U.S. Cl. CPC G01J 5/0018; G01J 5/0801; G01J 5/601; G01J 2005/0077; G01J 2005/608

(57) ABSTRACT

The present application provides a method and system for inferring an electron temperature from a hollow cathode plume color, applicable to diagnosis and inference of the electron temperature distribution of the hollow cathode under in-orbit or other vacuum environments. The method includes extraction of plume color data of the hollow cathode, two-dimensional processing of the plume color data, establishment of a correlation database between gridded colors and electron temperatures, and inference of the electron temperature distribution using the gridded colors. The inferred data of the electron temperature obtained in the present application exhibits trends consistent with measurement data obtained using a Langmuir probe, with diagnostic deviations within 30%. Based on the present application, researchers can directly leverage hollow cathode plume images to perform rapid, non-contact diagnosis of the electron temperature distribution characteristics.

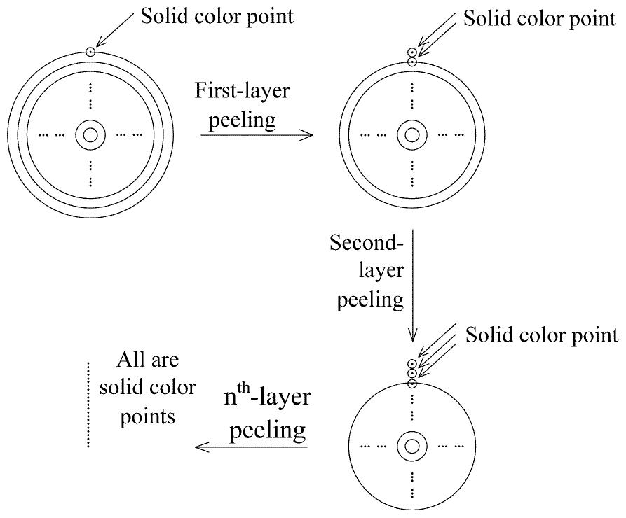

### CROSS REFERENCE TO RELATED APPLICATION

This patent application claims the benefit and priority of Chinese Patent Application No. 202411850924.0, filed with the China National Intellectual Property Administration on Dec. 13, 2024, the disclosure of which is incorporated by reference herein in its entirety as part of the present application.

### TECHNICAL FIELD

The present disclosure relates to the field of computation, and specifically, to a method and system for inferring an electron temperature from a hollow cathode plume color.

### BACKGROUND

In the field of electric propulsion, the hollow cathode plays a critical role. By utilizing the thermionic emission mechanism, it significantly lowers the vacuum barrier for solid-state electron emission. The hollow cathode not only provides ignition electrons and neutralizing electrons for the thruster, but also serves as a key determinant of electric thruster performance.

Characteristics of the electron temperature within a hollow cathode are of critical importance. These characteristics are directly linked to the electron emission capability and the cathode operational mode, serving as indispensable physical parameters for researchers when designing and optimizing cathode structures. However, the current state of technology presents significant challenges for studying the electron temperature within the hollow cathode. Due to the small internal space of the hollow cathode, precisely measuring the internal electron temperature distribution through experimental methods is highly difficult. This undoubtedly creates substantial obstacles for in-depth investigation of internal mechanisms and performance optimization and improvement of the hollow cathode. Consequently, non-contact diagnosis of the electron temperature within the hollow cathode has become a major focus in current research.

To date, among related studies, only the literature “Dan G, Kristina J, Ron W, et al. Hollow Cathode Theory and Experiment. I. Plasma Characterization Using Fast Miniature Scanning Probes. Journal of Applied Physics. 2005, 98: 1-9” has attempted diagnosis inside the hollow cathode using a single Langmuir probe. This probe is a single fine needle with a diameter of only 0.5 mm. By rapidly inserting and retracting the probe through the cathode orifice (for preventing probe sputtering), combined with fast voltage scanning technology, the internal electron temperature of the cathode can be obtained. However, the study also notes that this method introduces disturbances to the electron motion within the cathode, resulting in measurement deviations. Consequently, it is difficult for this approach to accurately reflect the true electron temperature distribution in the hollow cathode.

A search of patent literature revealed the patent CN118067401A, which discloses an in-orbit imaging monitoring apparatus and method for a coupling state between a Hall thruster and a cathode. The method includes first conducting imaging monitoring experiments on the coupling state between the Hall thruster and the cathode during ground tests, to obtain electron temperatures of an electron bridge in a coupling region of the Hall thruster under various operating conditions. Then, the electron temperatures of the electron bridge in the coupling region are measured by the satellite. The electron temperature measured in this case is compared with the electron temperature from the ground test under the same operating condition. If the two match, it indicates a good coupling state between the Hall thruster and the cathode; if they do not match, the voltage and current of the Hall thruster and the current of the hollow cathode are adjusted until consistency is achieved. This patent primarily focuses on the method for monitoring the coupling state between the Hall thruster and the cathode and adjusting the coupling state. It has shortcomings in aspects such as establishing a precise correlation database between plume colors and electron temperatures, and accurately identifying the specific positions corresponding to the electron temperatures.

In summary, addressing the problems in the prior art, researching a method and system for inferring an electron temperature from a hollow cathode plume color is a critical and urgent task.

### SUMMARY

In view of defects in the prior art, an objective of the present disclosure is to provide a method and system for inferring an electron temperature from a hollow cathode plume color.

A method for inferring an electron temperature from a hollow cathode plume color provided in the present disclosure includes the following steps:
step S1: extracting red, green, and blue (RGB) data from an image of a hollow cathode, and performing grid-based differential fitting on the extracted RGB data to obtain fitted RGB data;
step S2: performing two-dimensional profile extraction on the fitted RGB data to obtain profile RGB data;
step S3: based on the profile RGB data and atomic energy level transition rules, establishing a correlation database between gridded radiative colors and different electron temperatures; and
step S4: inferring an electron temperature distribution based on the profile RGB data and the correlation database.

Preferably, the step S1 includes the following sub-steps:
step S1.1: based on plume characteristics of the electric propulsion hollow cathode, capturing a brightest point of a plume, a cathode-plume boundary, an anode-plume boundary, and a cathode central axis, obtaining a cathode plume region envelope, and extracting the RGB data within the cathode plume region envelope; and
step S1.2: performing differential fitting of the RGB data (based on image pixel grids) onto computational domain grid nodes, to obtain the fitted RGB data that exhibits a three-dimensional axisymmetric form.

Preferably, in the step S1.2, a differential mode in the differential fitting adopts an area-weighted differential method, that is, a greater differential weight corresponds to a greater influence of a differential point on the computational domain grid node.

Preferably, the step S2 includes the following sub-steps:
step S2.1, first-layer peeling: based on the fitted RGB data, selecting a solid color point unaffected by color superposition at a top of a three-dimensional plume, and using the solid color point to eliminate color superposition contributed by a first circumferential layer in which the solid color point is located;
step S2.2, second-layer peeling: when a second solid color point appears at a top of a second circumferential layer of the three-dimensional plume, similarly using the second solid color point to eliminate color superposition contributed by the second circumferential layer; and
step S2.3: iteratively, after performing n^{th}-layer peeling, processing a color of the image into solid color points, thereby obtaining the profile RGB data required for computation.

Preferably, the peeling process includes: if a line of sight is formed by color superposition of m solid color points, a superimposed color is (r₁, g₁, b₁), and a color of a single solid color point is (rₚ, gₚ, bₚ), according to an axisymmetric property, two of the m solid color points (the foremost and rearmost points along the line of sight) have the same color as the single solid color point, that is, actual color data of a peeled circumferential layer; after peeling, colors of remaining (m−2) points on the line of sight are superimposed, resulting in a color (r₂, g₂, b₂), computed by the following formula:

$$( {r}_{2} , {g}_{2} , {b}_{2} ) = \frac{m ( {r}_{1} , {g}_{1} , {b}_{1} ) - 2 ( {r}_{p} , {g}_{p} , {b}_{p} )}{m - 2} \qquad ( 1 )$$

Preferably, the atomic energy level transition rules in the step S3 consider eight transition lines of an Xe atom from high energy levels to low energy levels, specifically: 8p→7p, 8p→6s₁′, 8p→6s₁, 6p′→6s₁′, 6p′→6s₁, 7p→6s₁, 6s₁′→1S₀, and 6s₁→1S₀, with corresponding transition probabilities of 1/2500, 1/333, 1/333, 1/1690, 1/1450, 1/658, 1/3.79, and 1/3.17, respectively.

Preferably, in the step S3, based on electron scattering cross-sections of the eight transition lines and corresponding electron temperatures, and assuming a uniform distribution of background atomic number density within a grid, radiative colors corresponding to the eight transition lines for gas discharge of Xe central gas under different electron temperatures are obtained; and the radiative colors are superimposed such that each of the different electron temperature within the grid corresponds to a unique grid background gas color, that is, the radiative colors and the different electron temperatures are in a one-to-one correspondence, thereby establishing the correlation database.

Preferably, the step S4 includes the following sub-steps:
step S4.1: determining, based on the profile RGB data and the correlation database, a specific electron temperature value that triggers the hollow cathode plume color;
step S4.2: considering that a position of atomic excitation collision differs from a position of photon emission by an atomic travel distance corresponding to an atomic excited-state lifetime, and given a background atomic number density distribution and a velocity distribution, obtaining the position of atomic excitation collision by subtracting the atomic travel distance corresponding to the atomic excited-state lifetime from the position of photon emission, thus determining the position corresponding to the electron temperature; and
step S4.3: obtaining electron temperature distribution data by combining the specific temperature value and the position corresponding to the electron temperature.

Preferably, in the step S4.2, a value of the atomic excited-state lifetime is a reciprocal of a transition probability.

The present disclosure further provides a system for inferring an electron temperature from a hollow cathode plume color, including:
a module M1 configured to extract red, green, and blue (RGB) data from an image of a hollow cathode, and perform grid-based differential fitting on the extracted RGB data to obtain fitted RGB data;
a module M2 configured to perform two-dimensional profile extraction on the fitted RGB data to obtain profile RGB data;
a module M3 configured to: based on the profile RGB data and atomic energy level transition rules, establish a correlation database between gridded radiative colors and different electron temperatures; and
a module M4 configured to infer an electron temperature distribution based on the profile RGB data and the correlation database.

Compared with the prior art, the present disclosure has the following beneficial effects.

1. The present disclosure performs diagnosis and inference of the electron temperature distribution of the hollow cathode under in-orbit or other vacuum environments, and the diagnostic data of the electron temperature exhibits trends consistent with diagnostic data obtained using a Langmuir probe, with diagnostic deviations within 30%.

2. The present disclosure enables non-contact diagnosis of the electron temperature within the hollow cathode, thereby supporting researchers in optimizing and designing cathode performance.

3. The present disclosure requires only hollow cathode plume images as input data, allowing for rapid analysis of cathode performance data from images in literature, as well as images captured during in-orbit or ground tests. This lays the foundation for related image recognition technologies.

### BRIEF DESCRIPTION OF THE DRAWINGS

Other features, objectives, and advantages of the present disclosure will become more apparent by reading the detailed description of non-limiting embodiments with reference to the following accompanying drawing.

The FIGURE is a schematic diagram of a two-dimensional profile extraction process according to the embodiments of the present disclosure.

### DETAILED DESCRIPTION OF THE EMBODIMENTS

The present disclosure is described in detail below with reference to specific embodiments. The following embodiments will help those skilled in the art to further understand the present disclosure, but do not limit the present disclosure in any way. It should be noted that several variations and improvements can also be made by a person of ordinary skill in the art without departing from the conception of the present disclosure. These all fall within the protection scope of the present disclosure.

The present disclosure innovatively proposes a non-contact diagnosis method for inferring an electron temperature from a hollow cathode plume color. By focusing on cathode plume images, the method first performs precise color data acquisition and detailed data processing. Then, based on the radiative energy-level spectral lines and principles of color superposition, the method infers the atomic de-excitation energy levels corresponding to the spectral colors, ultimately enabling successful inference of corresponding electron temperature data. This unique method integrates experimentally captured images with numerical algorithms, establishing a semi-theoretical, semi-experimental diagnosis model. It provides a novel and effective technical pathway for diagnosing electron temperature distributions of hollow cathodes, fills a gap in the prior art, and substantially advances development in the research related to hollow cathodes.

The present disclosure is applicable only to hollow cathodes commonly used in electric propulsion, that is, cathodes characterized by features such as hollow gas flow, enhanced ionization rates through beam effects, and thermionic emission mechanisms of the emitter. Diagnostic uncertainties may arise when applied outside this application scope.

### Embodiment 1

This embodiment provides a method for inferring an electron temperature from a hollow cathode plume color, including the following steps:

In step S1, RGB data is extracted from an image of a hollow cathode, and grid-based differential fitting is performed on the extracted RGB data to obtain fitted RGB data.

Specifically, step S1 includes the following sub-steps:

In step S1.1, based on plume characteristics of the electric propulsion hollow cathode, a brightest point of a plume, a cathode-plume boundary, an anode-plume boundary, and a cathode central axis are captured, a cathode plume region envelope is obtained, and the RGB data within the cathode plume region envelope is extracted.

In step S1.2, differential fitting of the RGB data (based on image pixel grids) is performed onto computational domain grid nodes, to obtain the fitted RGB data that exhibits a three-dimensional axisymmetric form.

In this embodiment, a differential mode in the differential fitting adopts an area-weighted differential method, that is, a greater differential weight corresponds to a greater influence of a differential point on the computational domain grid node.

In step S2, two-dimensional profile extraction is performed on the fitted RGB data to obtain profile RGB data.

The FIGURE is a schematic diagram of a two-dimensional profile extraction process according to the embodiments of the present disclosure.

As shown in the FIGURE, step S2 includes the following sub-steps:

In step S2.1, first-layer peeling is performed: based on the fitted RGB data, a solid color point unaffected by color superposition at a top of a three-dimensional plume is selected, and the solid color point is used to eliminate color superposition contributed by a first circumferential layer in which the solid color point is located.

In step S2.2, second-layer peeling is performed: when a second solid color point appears at a top of a second circumferential layer of the three-dimensional plume, the second solid color point is similarly used to eliminate color superposition contributed by the second circumferential layer.

In step S2.3, iteratively, after performing n^{th}-layer peeling, a color of the image is processed into solid color points, thereby obtaining the profile RGB data required for computation.

Specifically, the peeling process includes: if a line of sight is formed by color superposition of m solid color points, a superimposed color is (r₁, g₁, b₁), and a color of a single solid color point is (rₚ, gₚ, bₚ), according to an axisymmetric property, two of the m solid color points (the foremost and rearmost points along the line of sight) have the same color as the single solid color point, that is, actual color data of a peeled circumferential layer; after peeling, colors of remaining (m−2) points on the line of sight are superimposed, resulting in a color (r₂, g₂, b₂), computed by the following formula:

$$( {r}_{2} , {g}_{2} , {b}_{2} ) = \frac{m ( {r}_{1} , {g}_{1} , {b}_{1} ) - 2 ( {r}_{p} , {g}_{p} , {b}_{p} )}{m - 2} \qquad ( 1 )$$

In step S3, based on the profile RGB data and atomic energy level transition rules, a correlation database between gridded radiative colors and different electron temperatures is established.

Xe is used as an example in this embodiment, and eight transition lines of the Xe atom from high energy levels to low energy levels are considered, specifically: 8p→7p, 8p→6s₁′, 8p→6s₁, 6p′→6s₁′, 6p′→6s₁, 7p→6s₁, 6s₁′→1S₀, and 6s₁→1S₀, with corresponding transition probabilities of 1/2500, 1/333, 1/333, 1/1690, 1/1450, 1/658, 1/3.79, and 1/3.17, respectively.

Specifically, based on electron scattering cross-sections of the eight transition lines and corresponding electron temperatures, and assuming a uniform distribution of background atomic number density within a grid, radiative colors corresponding to the eight transition lines for gas discharge of Xe central gas under different electron temperatures are obtained; and the radiative colors are superimposed such that any electron temperature within the grid corresponds to a unique grid background gas color, that is, the colors and the temperatures are in a one-to-one correspondence, thereby establishing the correlation database.

In step S4, electron temperature distribution is inferred based on the profile RGB data and the correlation database.

Step S4 includes the following sub-steps:

In step S4.1, based on the profile RGB data and the correlation database, a specific electron temperature value that triggers the color is determined.

In step S4.2, considering that a position of atomic excitation collision differs from a position of photon emission by an atomic travel distance corresponding to an atomic excited-state lifetime, and given a background atomic number density distribution and a velocity distribution, the position of atomic excitation collision is obtained by subtracting the atomic travel distance corresponding to the atomic excited-state lifetime from the position of photon emission, thus determining the position corresponding to the electron temperature.

A value of the atomic excited-state lifetime is a reciprocal of the transition probability.

In step S4.3, electron temperature distribution data is obtained by combining the specific temperature value and the position corresponding to the electron temperature.

### Embodiment 2

The present disclosure further provides a system for inferring an electron temperature from a hollow cathode plume color, which can be implemented by executing the steps of the method for inferring an electron temperature from a hollow cathode plume color. That is, a person skilled in the art can take the method for inferring an electron temperature from a hollow cathode plume color as a preferred embodiment of the system for inferring an electron temperature from a hollow cathode plume color.

The system includes:
a module M1 configured to extract RGB data from an image of a hollow cathode, and perform grid-based differential fitting on the extracted RGB data to obtain fitted RGB data;
a module M2 configured to perform two-dimensional profile extraction on the fitted RGB data to obtain profile RGB data;
a module M3 configured to: based on the profile RGB data and atomic energy level transition rules, establish a correlation database between gridded radiative colors and different electron temperatures; and
a module M4 configured to infer an electron temperature distribution based on the profile RGB data and the correlation database.

The spirit and principles of the present disclosure include: extracting RGB color data from hollow cathode plume images and performing data differential fitting operations; applying a peeling method to transform the plume RGB data, which exhibits a three-dimensional axisymmetric form, into two-dimensional profile data; then establishing a correlation database between the gridded radiative colors and different electron temperatures; and finally inferring the electron temperature distribution data based on this database and the atomic travel distance corresponding to the atomic excited-state lifetime. Any modification of empirical coefficients, substitution of cathode materials, replacement of gas species, or equivalent transformation of formulas conducted within this spirit and principles shall fall within the protection scope of the present disclosure.

The specific embodiments of the present disclosure are described above. It should be understood that the present disclosure is not limited to the above specific implementations, and a person skilled in the art can make various variations or modifications within the scope of the claims without affecting the essence of the present disclosure. The embodiments in the present application and the characteristics in the embodiments can be combined mutually in the case of no conflict.

What is claimed is:

1. A method for inferring an electron temperature from a hollow cathode plume color, comprising following steps:
step S1: extracting red, green, and blue (RGB) data from an image of a hollow cathode, and performing grid-based differential fitting on the extracted RGB data to obtain fitted RGB data;
step S2: performing two-dimensional profile extraction on the fitted RGB data to obtain profile RGB data;
step S3: based on the profile RGB data and atomic energy level transition rules, establishing a correlation database between gridded radiative colors and different electron temperatures; and
step S4: inferring an electron temperature distribution based on the profile RGB data and the correlation database.

2. The method for inferring an electron temperature from a hollow cathode plume color according to claim 1, wherein the step S1 comprises following sub-steps:
step S1.1: based on plume characteristics of the electric propulsion hollow cathode, capturing a brightest point of a plume, a cathode-plume boundary, an anode-plume boundary, and a cathode central axis, obtaining a cathode plume region envelope, and extracting the RGB data within the cathode plume region envelope; and
step S1.2: performing differential fitting of the RGB data onto computational domain grid nodes, to obtain the fitted RGB data, wherein the fitted RGB data is in a three-dimensional axisymmetric form.

3. The method for inferring an electron temperature from a hollow cathode plume color according to claim 2, wherein in the step S1.2, a differential mode in the differential fitting adopts an area-weighted differential method, that is, a greater differential weight corresponds to a greater influence of a differential point on the computational domain grid node.

4. The method for inferring an electron temperature from a hollow cathode plume color according to claim 1, wherein the step S2 comprises following sub-steps:
step S2.1, first-layer peeling: based on the fitted RGB data, selecting a solid color point unaffected by color superposition at a top of a three-dimensional plume, and using the solid color point to eliminate color superposition contributed by a first circumferential layer in which the solid color point is located;
step S2.2, second-layer peeling: when a second solid color point appears at a top of a second circumferential layer of the three-dimensional plume, similarly using the second solid color point to eliminate color superposition contributed by the second circumferential layer; and
step S2.3: iteratively, after performing n^{th}-layer peeling, processing a color of the image into solid color points, thereby obtaining the profile RGB data required for computation.

5. The method for inferring an electron temperature from a hollow cathode plume color according to claim 4, wherein a peeling process comprises: if a line of sight is formed by color superposition of m solid color points, a superimposed color is (r₁, g₁, b₁), and a color of a single solid color point is (rₚ, gₚ, bₚ), according to an axisymmetric property, two of the m solid color points have a same color as the single solid color point, that is, actual color data of a peeled circumferential layer; after peeling, colors of remaining (m−2) points on the line of sight are superimposed, resulting in a color (r₂, g₂, b₂), computed by following formula:
$$( {r}_{2} , {g}_{2} , {b}_{2} ) = \frac{m ( {r}_{1} , {g}_{1} , {b}_{1} ) - 2 ( {r}_{p} , {g}_{p} , {b}_{p} )}{m - 2} . \qquad ( 1 )$$

6. The method for inferring an electron temperature from a hollow cathode plume color according to claim 1, wherein the atomic energy level transition rules in the step S3 consider eight transition lines of an Xe atom from high energy levels to low energy levels, specifically: 8p→7p, 8p→6s₁′, 8p→6s₁, 6p′→6s₁′, 6p′→6s₁, 7p→6s₁, 6s₁′→1S₀, and 6s₁→1S₀, with corresponding transition probabilities of 1/2500, 1/333, 1/333, 1/1690, 1/1450, 1/658, 1/3.79, and 1/3.17, respectively.

7. The method for inferring an electron temperature from a hollow cathode plume color according to claim 6, wherein in the step S3, based on electron scattering cross-sections of the eight transition lines and corresponding electron temperatures, and assuming a uniform distribution of background atomic number density within a grid, radiative colors corresponding to the eight transition lines for gas discharge of Xe central gas under different electron temperatures are obtained; and the radiative colors are superimposed such that each of the different electron temperatures within the grid corresponds to a unique grid background gas color, that is, the radiative colors and the different electron temperatures are in a one-to-one correspondence, thereby establishing the correlation database.

8. The method for inferring an electron temperature from a hollow cathode plume color according to claim 1, wherein the step S4 comprises following sub-steps:
step S4.1: determining, based on the profile RGB data and the correlation database, a specific electron temperature value that triggers the hollow cathode plume color;
step S4.2: considering that a position of atomic excitation collision differs from a position of photon emission by an atomic travel distance corresponding to an atomic excited-state lifetime, and given a background atomic number density distribution and a velocity distribution, obtaining the position of atomic excitation collision by subtracting the atomic travel distance corresponding to the atomic excited-state lifetime from the position of photon emission, thus determining the position corresponding to the electron temperature; and
step S4.3: obtaining electron temperature distribution data by combining the specific temperature value and the position corresponding to the electron temperature.

9. The method for inferring an electron temperature from a hollow cathode plume color according to claim 8, wherein in the step S4.2, a value of the atomic excited-state lifetime is a reciprocal of a transition probability.

10. A system for inferring an electron temperature from a hollow cathode plume color, comprising:
a module M1 configured to extract red, green, and blue (RGB) data from an image of a hollow cathode, and perform grid-based differential fitting on the extracted RGB data to obtain fitted RGB data;
a module M2 configured to perform two-dimensional profile extraction on the fitted RGB data to obtain profile RGB data;
a module M3 configured to: based on the profile RGB data and atomic energy level transition rules, establish a correlation database between gridded radiative colors and different electron temperatures; and
a module M4 configured to infer an electron temperature distribution based on the profile RGB data and the correlation database.
